(19) United States
(12) Patent Application Publication
(10) Pub. No.: US 2018/0165643 A1
(43) Pub. Date: Jun. 14, 2018

(54) METHODS AND SYSTEMS FOR ORGANIZING DISPATCH MATTERS FOR FREIGHT SERVICES

(71) Applicant: Flexport, Inc., San Francisco, CA (US)

(72) Inventors: Andrew COYLE, San Francisco, CA (US); Anthony CHEN, San Francisco, CA (US); Sean LINEHAN, San Francisco, CA (US); Jonathan OPRAY, San Francisco, CA (US)

(21) Appl. No.: 15/808,738

(22) Filed: Nov. 9, 2017

Related U.S. Application Data
(60) Provisional application No. 62/419,936, filed on Nov. 9, 2016.
(60) Provisional application No. 62/428,459, filed on Nov. 30, 2016.
(60) Provisional application No. 62/560,603, filed on Sep. 19, 2017.
(60) Provisional application No. 62/557,741, filed on Sep. 12, 2017.
(60) Provisional application No. 62/555,593, filed on Sep. 7, 2017.

(51) Int. Cl. G06Q 10/08

(52) U.S. Cl. CPC G06Q 10/08355; G06Q 10/0838

(57) ABSTRACT

This disclosure pertains to methods and systems for organizing dispatch matters for managing the movement of mass. In one embodiment, the methods and systems disclosed herein comprise an aggregate of dispatch matters presented on a Physical, Tangible Display Means. In one embodiment, an exception event changes the arrangement of dispatch matters.

### CROSS REFERENCE TO RELATED APPLICATIONS

This application claims priority to U.S. Provisional Application No. 62/419,936 filed Nov. 9, 2016, U.S. Provisional Application No. 62/428,459 filed Nov. 30, 2016, U.S. Provisional Application No. 62/560,603 filed Sep. 19, 2017, U.S. Provisional Application No. 62/557,741 filed Sep. 12, 2017, and U.S. Provisional Application No. 62/555,593 filed Sep. 7, 2017, all of which are hereby incorporated by reference in their entirety.

### TECHNICAL FIELD

This disclosure relates to the shipping industry. In particular, this disclosure relates to methods and systems for providing and managing end to end freight services.

### BACKGROUND

Today's economy requires a need to service a global market, to serve not only a domestic market but also an international market as well. In the case of products like textiles, clothing, books, consumer electronics, toys, bikes, food products, etc., it has become imperative to deliver these goods to anyone in the world. The advent of an E-commerce market has provided these opportunities.

However, international shipping poses several problems. Shipping goods on a large scale to foreign markets normally requires the use of a freight service. A freight service operates by using a ship, airplane, truck, and/or train to ship a large amount of mass across long distances. Moving mass also includes aspects that facilitate the movement of said mass, e.g., providing insurance, clearing customs, paying fees, etc. Therefore, a combination of different services is required in order to bring an object to its final destination. In one scenario, a truck may bring the goods from a warehouse to an airplane, then the airplane travels across country, and then another truck service will take the goods to its final destination.

Moving objects across the globe requires extensive coordination and paperwork. This is especially important for transporting goods in and out of different countries where there are many different laws and regulations for transporting goods. The process of shipping goods poses significant logistical challenge, e.g., abiding by all necessary laws and regulations, monitoring the movement of mass, ensuring the proper paperwork, etc. To that end, many companies dedicate an entire division for keeping track of deliveries.

However, the shipping division of most companies rely on outdated methods for bookkeeping. Manually calling, e-mailing, and/or faxing companies is slow, complicated, and time consuming. The constant flow of business, daily changes, and unexpected delays makes these methods antiquated for a digital market.

If a company has multiple deliveries occurring at the same time organizing all the documents, shipments, dates, etc., becomes overly complicated. Using calendars, tables, and computers are a few ways to address the issue, but these methods are disjointed and only provide a limited number of ways to view the information.

First, the information is spread across several different platforms leaving one without the ability to condense the information into a single format. Second, the different types of mediums limit the ability for one person to manage a large number of deliveries at the same time. Third, focusing on a single aspect for multiple deliveries creates blind spots preventing a person from understanding the entire spectrum of the delivery. Meaning, several people would need to work on the deliveries at the same time in order to manage all the deliveries, but from separate viewpoints. Diverting manpower, time, and resources from other needed areas.

There exists a need for managing shipping matters in a convenient format. There also exists a need to manage shipping matters in an efficient and easy to use format. There also exists a need to efficiently manage such matters such that businesses can handle many clients at a time. There also exists a need for distributing information through a network.

### DETAILED DESCRIPTION

Disclosed herein are new methods and systems for managing the multitude of processes required for moving mass efficiently and easily. In one embodiment, managing comprises a user facilitating the movement of mass on behalf of a client. In one embodiment, the methods and systems disclosed herein automatically aggregate dispatch matters. In one embodiment, the methods and systems disclosed herein automatically arrange dispatch matters. In one embodiment, the methods and systems disclosed herein prompt a user for input at one or more steps within the arrangement of dispatch matters, e.g., soliciting information regarding preference of organization, priority of dispatch matters, type of dispatch matter, etc.

In one embodiment, the methods and systems disclosed herein utilize user input for efficiently organizing and managing the movement of mass, e.g., a user choosing the arrangement of dispatch matters, a user filtering dispatch matters, a user selecting dispatch matters, etc. In one embodiment, the methods and systems disclosed herein comprise a Physical, Tangible Display Means, e.g., a computer, a screen, a mobile device, a printed document, etc. In one embodiment, a user interacts with a Physical, Tangible Display Means for facilitating the movement of mass, e.g., executing dispatch matters, managing the movement of mass, arranging dispatch matters, tracking changes or developments involved in moving mass, etc.

Disclosed herein are new methods and systems for presenting dispatch matters to a network of users and/or clients, e.g., presenting information to a plurality of people involved in moving mass from one location to another location. In one embodiment, the methods and systems disclosed herein comprise processing data for generating dispatch matters. In one embodiment, the methods and systems disclosed herein comprise sorting and/or filtering dispatch matters. In one embodiment, the methods and systems disclosed herein automatically aggregate and display dispatch matters in a way that allows a user and/or client to engage in efficient decision making. In one embodiment, the systems and methods disclosed herein comprise presenting dispatch matters based on user preference. In one embodiment, the systems and methods disclosed herein comprise utilizing historical data for rapid data processing. In one embodiment, the systems and methods disclosed herein comprise recommending actions. In one embodiment, a user and/or client operates the system or uses the methods disclosed herein to address dispatch matters to facilitate the movement of mass. For example, the systems and methods disclosed herein facilitate moving mass by performing one or more of the following steps: coordinating a series of actions, accomplishing dispatch matters, resolving issues arising during movement, forecasting potential roadblocks, etc.

Disclosed herein is a method of managing an end to end freight service, comprising:
accessing a freight shipping itinerary;
extracting a collection of dispatch matters from the freight shipping itinerary; and
presenting the collection of dispatch matters on a display according to a user's inputted criteria.

As used herein, the term “client” refers to an entity possessing, controlling, and/or owning a Physical, Concrete and Tangible Object. In one embodiment, a client uses the methods and systems disclosed herein to move a Physical, Concrete and Tangible Object from one geographic location to another geographic location. In one embodiment, a user of the systems and/or methods disclosed herein assists a client with moving a Physical, Concrete and Tangible Object from one physical location to another physical location. In one embodiment, the methods and systems disclosed herein automatically create a freight shipping itinerary for the movement of a Physical, Concrete and Tangible Object from one location to another location, e.g., by using historical data to decide, suggest, or execute one or more of the steps required for moving mass, creating a route from the chosen freight services, prompting input from a user and/or client, etc. In one embodiment, a client manually performs one or more of these (or related) steps while the systems and methods disclosed herein assists with other steps.

As used herein, the term “user” refers to an entity practicing the methods or using the systems as disclosed herein. Within the context of this disclosure, the term “user” includes a person interacting with software, for example a service provider managing a client's freight shipping itinerary, e.g., listing and monitoring tasks and due dates on a computer. In one embodiment, a user assists in efficiently managing a supply chain for keeping products in the stream of commerce, e.g., by maintaining the number of products in an inventory, tracking the movement of mass, ensuring quality compliance, prompting a client for input, etc. In one embodiment, a user assists in the execution of each step involved in moving a Physical, Concrete and Tangible Object from one location to another location. In one embodiment, a user utilizes the methods and systems disclosed herein to manage the steps required for moving a mass from one location to another location.

As used herein, the term “freight shipping itinerary” refers to a set of steps for the movement of a Physical, Concrete and Tangible Object from one location to another location along a route. Exemplary steps for the movement of a Physical, Concrete and Tangible include, but are not limited to, acquiring insurance, submitting forms to a federal agency, paying a freight service for moving mass, loading and unloading mass, clearing a customs check, the moving mass along a route, etc. In one embodiment, the methods and systems disclosed herein comprise multiple freight shipping itineraries. In one embodiment, a freight shipping itinerary comprises logistical information, e.g., the route of movement, an arrival date at one or more places, stops along a route, a total cost for service, etc. In one embodiment, the methods and systems disclosed herein automatically create a freight shipping itinerary, e.g., by utilizing historical data from previous shipments, prompting a user for input about specific criteria or preferences, and using that information to determine the best itinerary possible. In one embodiment, the methods and systems disclosed herein present two or more options for a freight shipping itinerary. In one embodiment, the methods and systems disclosed herein rank two or more freight shipping itineraries. In one embodiment, the methods and systems disclosed herein create a freight shipping itinerary based on a user and/or client's input. In one embodiment, the methods and systems disclosed herein prompt a user and/or client for input, e.g., soliciting information regarding the preference of transportation method, range of cost, preferred date of arrival, etc. In one embodiment, a freight shipping itinerary is presented on a Physical, Tangible Display Means, e.g., a computer, a screen, a mobile device, etc.

In one embodiment, a freight shipping itinerary changes, e.g., new steps are added, one or more steps are removed, the arrangement of steps is changed, the timeline of one or more steps, etc. In one embodiment, the methods and systems disclosed herein allow for dynamically changing a freight shipping itinerary based on real time changes, e.g., accomplishment of a dispatch matter, a change in a route, an exception event occurring, etc. In one embodiment, the freight shipping itinerary automatically changes. In one embodiment, an exception rearranges the order of steps for a freight shipping itinerary.

In one embodiment, a freight shipping itinerary comprises the geographic location of a Physical, Concrete and Tangible Object that's moving in transit, e.g., the latitudinal and longitudinal coordinates of a Physical, Concrete and Tangible Object while the Physical, Concrete and Tangible Object is moving on a ship, train, truck, and/or train. In one embodiment, the methods and systems disclosed herein automatically track the movement of a Physical, Concrete and Tangible Object. In one embodiment, a new step is created while the mass is moving, e.g., changing the itinerary to address an issue at customs, approving a new route, rerouting mass to meet real time demands, creating a new shipment to accommodate for lost goods, etc.

As used herein, the term “accessing a freight shipping itinerary” refers to retrieving the individual steps involved in accomplishing the movement of mass from one location to another location. In one embodiment, accessing a freight shipping itinerary comprises allowing a user to access a client's database, e.g., utilizing a Cloud database to share information, transferring data using an application interface program, transferring information between mobile devices, sending documents, etc. In one embodiment, the methods and systems disclosed herein automatically access a freight shipping itinerary without input from a user and/or client, e.g., sharing information with a Cloud database, transferring information with an application program interface, etc. In one embodiment, accessing a freight shipping itinerary comprises retrieving all the individual transactions for the movement of a Physical, Concrete and Tangible Object. In one embodiment, accessing a freight shipping itinerary comprises retrieving all the individual transactions for the movement of two or more Physical, Concrete and Tangible Objects. In one embodiment, accessing a freight shipping itinerary is performed on an hourly basis. In one embodiment, accessing a freight shipping itinerary is performed on a daily basis. In one embodiment, accessing a freight shipping itinerary is performed on a weekly basis. In one embodiment, accessing a freight shipping itinerary is performed on a monthly basis. In one embodiment, accessing a freight shipping itinerary is performed in real time.

As used herein, the term “real time” refers to an event occurring contemporaneously, e.g., an event presently occurring in the natural world or a current up to date state or condition. Within the context of this disclosure, term “real time” is understood to not mean the exact time an event occurs, e.g., the delay in time for recording the occurrence of an event to a computer, the delay in time when witnessing an event and registering the event, etc. In one embodiment, accessing a freight shipping itinerary in real time allows a user to continuously monitor the movement of mass, providing the quickest notice of changes to a movement of mass to a user and/or client.

As used herein, the term “dispatch matter” refers to input relevant for moving a Physical, Tangible and Concrete Object from one location to another location, e.g., an action requiring a response or information relevant thereto. In one embodiment, a dispatch matter is any action, issue, circumstance, event, and/or transaction that a user and/or client addresses and/or responds to. In one embodiment, a dispatch matter is any logistical information relevant for moving mass. In one embodiment, a dispatch matter is generated from a freight shipping itinerary by analyzing all the individual steps required for managing the movement of mass. In one embodiment, the methods and systems disclosed herein automatically track the steps required for moving mass and creates a concrete representation for each step individually, as a set of steps, or as a collection of all steps, e.g., defining a logical progression of distinguishable actions, presenting dispatch matters on a Physical, Tangible Display Means, comparing historical data, etc. In one embodiment, addressing a dispatch matter facilitates and manages the movement of a mass, e.g., by paying a fee to a service provider, confirming a delivery date, submitting a regulatory form, etc. In one embodiment, a dispatch matter is automatically created upon creating a freight shipping itinerary. In one embodiment, a dispatch matter is created during the movement of mass. In one embodiment, a dispatch matter is created using historical data, e.g., reviewing previous freight shipping itineraries and recognizing relevant actions. In one embodiment, the methods and systems disclosed herein automatically record the creation of a dispatch matter. In one embodiment, a user and/or client inputs a dispatch matter. In one embodiment, the methods and systems disclosed herein present an aggregate of all dispatch matters. In one embodiment, a user and/or client controls the arrangement and presentation of all dispatch matters, e.g., utilizing a graphical user interface to manipulate a concrete representation, inputting preferences to change the arrangement of a concrete representation, filtering a concrete representation, sorting columns, rows, etc., by time, price, etc.

Examples of dispatch matters within the context of this disclosure include, but are not limited to, seller contact information, partner, rate expired, shipment schedule, confirming shipment schedule, schedule sent, Importer Security Filing (ISF), ISF worksheet, sending bill of lading(s) to partner, ISF worksheet for customs broker, waiting for ISF, ISF entry, shipment pickup from seller, shipment arrival at feeder port, shipment departure from feeder port, shipment arrived at origin, airway bill, commercial Invoice, packing list, shipment departed from origin, bill of lading, house and master bill numbers, pre-alert partner, arrival Notice, arrival agent payment, statement of accounts reminder, trucker, trucking reference number, send arrival notice to broker, customs cleared, customs entry number, customs entry summary, customs release, delivery order, invoice with customs duties, rated commercial invoice, shipment arrived at destination, shipment pickup from destination airport, warehouse payment, aviation Safety Network, delivery appointment, shipment arrived at inland port, shipment picked up from inland port, shipment delivered to final destination, drop and pickup containers, proof of delivery, all invoices, completion of shipment, etc.

In one embodiment, a user and/or client executes a dispatch matter with the methods and systems disclosed herein, e.g., sending a form to a government agency, sending payment to a service provider, confirming an action, etc. In one embodiment, the methods and systems disclosed herein facilitate the movement of mass by providing materials for accomplishing dispatch matters, e.g., providing a government form, presenting a recommendation of actions, presenting historical data for more efficient decision making, etc.

In one embodiment, the methods and systems disclosed herein comprise more than one user. In one embodiment, multiple users address multiple dispatch matters for efficiently managing the movement of mass without isolating their activity from the activity of other users. This presents an advantage over other technology by allowing users to accomplish separate tasks while still collaborating to efficiently manage the movement of mass. In one example, a user monitors a shipping schedule and another user confirms a shipment schedule. In one embodiment, two or more users operate the systems and/or use the methods disclosed herein, working separately while also maintaining the ability to view, monitor, approve, reject, or comment on the work of each other. A significant advantage of the methods and systems disclosed herein over the available technology is the ability to work separately, within the same network, without isolating each user or their work products from one another. In one embodiment, a group of users has access to the same freight shipping itinerary. In one embodiment, a group of users have different levels of access to each other's work, e.g., one user has the ability to view the work of all the users, a set of users have access to only certain information, etc.

As used herein, the term “collection of dispatch matters” refers to a compilation of input relevant for moving a Physical, Concrete and Tangible Object from one location to another location. In one embodiment, the collection of dispatch matters comprises all the information relevant to moving mass. In one embodiment, the systems and methods disclosed herein automatically generate a collection of dispatch matters is automatically generated from a freight shipping itinerary. In one embodiment, a user and/or client controls how a collection of dispatch matters are arranged, e.g., utilizing a graphical user interface to change the arrangement of a concrete representation, selecting specific dispatch matters, manipulating the order of a concrete representation of dispatch matters, etc. In one embodiment, the methods and systems disclosed herein automatically arrange a collection of dispatch matters in a preferred order. In one embodiment, a collection of dispatch matters is automatically generated by utilizing historical data, e.g., storing data for previous shipments to quickly create a collection of dispatch matters.

As used herein, the term “extracting a collection of dispatch matters from the freight shipping itinerary” refers to analyzing, creating, generating, categorizing, processing, and/or receiving dispatch matters from a freight shipping itinerary. In one embodiment, the methods and systems disclosed herein automatically extract a collection of dispatch matters from a freight shipping itinerary. In one embodiment, extracting a collection of dispatch matters from a freight shipping itinerary comprises prompting a user and/or client for information, e.g., presenting a pop up alert on a Physical, Tangible Display Means, sending a visual message for approval and/or confirmation, utilizing an in-app alert for missing information, etc. In one embodiment, a client and/or user is prompted to input information, e.g., a start location and destination location, freight services used, the type of mass being moved, etc.

In one embodiment, each individual movement of mass comprises a universe of dispatch matters that is varied, numerous, and unique to that particular mass. In one example, moving a Physical, Concrete and Tangible Object comprises entering and leaving different countries. Each movement in and out of a country requires a set of dispatch matters unique to each movement.

In one embodiment, the same type or types of dispatch matters occur in separate deliveries. In one embodiment, extracting a collection of dispatch matters from the freight shipping itinerary produces manageable pieces of information that are contemporaneously or subsequently sorted and/or filtered. In one embodiment, the methods and systems disclosed herein comprise utilizing historical data for recognizing dispatch matters from a freight shipping itinerary, e.g., recognizing similar steps from previous deliveries, learning from previous deliveries that new dispatch matters are required or advised for improving future shipments or steps within them, relying on a user preference, etc.

As used herein, the term “presenting the collection of dispatch matters on a Physical, Tangible Display Means” refers to displaying a collection of dispatch matters on a concrete medium. In one embodiment, presenting the collection of dispatch matters comprises displaying an aggregate of dispatch matters. In one embodiment, presenting a collection of dispatch matters on a Physical, Tangible Display means comprises utilizing a graphical user interface. In one embodiment, the Physical, Tangible Display Means comprises a screen. In one embodiment, the Physical, Tangible Display Means comprises a computer. In one embodiment, the Physical, Tangible Display Means comprises a mobile device. In one embodiment, the Physical, Tangible Display Means comprises a print out. In one embodiment, the Physical, Tangible Display Means comprises a paper. In one embodiment, the Physical, Tangible Display Means comprises a facsimile. In one embodiment, presenting a collection of dispatch matters on a Physical, Tangible Display Means comprises alerting a user and/or client, e.g., an approaching due date for a dispatch matter, the creation of a new dispatch matter, an exception event occurring, etc. In one embodiment, the methods and systems disclosed herein automatically present a collection of dispatch matters on a Physical, Tangible Display Means.

In one embodiment, a user of the systems and methods disclosed alerts a client with the methods and systems disclosed herein. In one embodiment, alerting a client comprises prompting an action from a client. In one embodiment, alerting a client comprises providing a recommendation to a client, e.g., a sequential order of addressing dispatch matters, a method of accomplishing a dispatch order, etc. In one embodiment, alerting a user and/or client comprises requesting input from a user and/or client. In one embodiment, alerting a client comprises informing a client about an action, e.g., informing a client about clearing customs, approving a change in shipment, etc. In one embodiment, the methods and systems disclosed herein alert a client automatically, e.g., sending an alert without restrictions from a client, sending an alert without input from a user (e.g., confirmation before sending), etc. In one embodiment, the methods and systems disclosed herein alert a client semi-automatically, e.g., limiting the number of alerts before alerting, sending only a certain type of alert, requiring confirmation of user before alerting a client, etc.

Within the context of this disclosure, the term “graphical user interface”, aka GUI, refers to a configuration and/or layout of information (including text, graphics, pictures, illustrations, icons, charts, graphics, etc.) presented on a Physical, Tangible Display Means. In one embodiment, the Physical, Tangible Display Means comprises a monitor. In one embodiment, the Physical, Tangible Display Means comprises a computer. In one embodiment, the Physical, Tangible Display Means comprises a mobile device. In one embodiment of this disclosure, the Physical, Tangible Display Means comprises channels, e.g., web/mobile, internet, email, etc.

In one embodiment, a graphical user interface controls a concrete presentation of a collection of dispatch matters. In one embodiment, a graphical user interface comprises a drop-down menu. The drop-down menu comprises options for a user and/or client to select to arrange the concrete presentation of a collection of dispatch matters. In one embodiment, the methods and systems disclosed herein automatically present a collection of dispatch matters based on a user's and/or client's preference, e.g., presenting a collection of dispatch matters based on previously chosen parameters. In one embodiment, a graphical user interface comprises symbols and/or icons, e.g., representations of a route, a list of dispatch matters, numbers, etc., for a client and/or user to interact with, e.g., using a mouse and/or touch screen to move objects, inputting information with a keyboard, etc. In one embodiment, a user and/or client operates a graphical user interface with a keyboard, mouse, voice recognition, touch screen, etc.

As used herein, the term “according to a user's inputted criteria” refers to arranging a collection of dispatch matters based on a user's selected parameters. In one embodiment, choosing the arrangement of dispatch matters enables a user to evaluate the client status of the movement of mass in the manner the user desires. Users will vary in their preference of managing the movement of mass and the methods and systems disclosed herein provide unprecedented control for users to select the concrete representation of information. In one embodiment, the user organizes the dispatch matters by due date to address pending dispatch matters in order of their respective timelines. In one embodiment, the dispatch matters are presented by client status, which enables a user to view the workload asserted with a particular client.

Within the context of this disclosure, “client status” refers to the current activity regarding the movement of a Physical, Concrete and Tangible Object and/or all the dispatch matters addressed and/or pending. In one embodiment, client status comprises the amount of time until a Physical, Concrete and Tangible Object arrives at a location. In one embodiment, client status comprises payment of all fees. In one embodiment, client status comprises the real-time location of a Physical, Concrete and Tangible Object.

In one embodiment, a user is presented with an aggregate of all the dispatch matters having a particular parameter, which may be chosen by a user. This collection and presentation of information allows a user to focus on specific aspects of a collection of deliveries at the same time as opposed to manually filtering, curating, and sorting deliveries. This collection and presentation is particularly valuable for assigning dispatch matters to individual users for managing multiple freight shipping itineraries at the same time. In one example, a user is assigned with the task of ensuring payment of all services while another user ensures compliance with customs agencies.

In one embodiment, the collection of dispatch matters is arranged by overdue dispatch matters. In one embodiment, the collection of dispatch matters is arranged by the amount of dispatch matters addressed. In one embodiment, the collection of dispatch matters is arranged by client status, e.g., the current location of a Physical, Concrete and Tangible Object, the amount of time before delivery, etc. In one embodiment, the collection of dispatch matters is arranged by shipment. In one embodiment, the collection of dispatch matters is arranged by purchase order.

In one embodiment, the user's inputted criteria comprise a geographic location.

As used herein, the term “geographic location” refers to the physical position of a Physical, Concrete and Tangible Object. In one embodiment, the geographic location is the starting location. In one embodiment, the geographic location is the end location. In one embodiment, the geographic location is the location of a customs agency. In one embodiment, the geographic location is the contemporaneous (or last available) position of a Physical, Concrete and Tangible Object while the Physical, Concrete and Tangible Object is in transit, e.g., on a ship, airplane, truck, and/or train.

In one embodiment, the user's inputted criteria comprise a due date.

As used herein, the term “due date” refers to the designated day on or before which a dispatch matter must be accomplished and/or addressed. In one embodiment, the due date is when payment of services must be rendered. In one embodiment, the due date is the day for submitting a form for processing to occur in a timely manner. In one embodiment, the due date includes a specific time of the day, e.g., hour, minute, and second. In one embodiment, dispatch matters are arranged by their respective due dates in chronological order for ensuring delivery in an efficient manner. In one embodiment, the methods and systems disclosed herein automatically track and/or record all due dates. In one embodiment, the methods and systems disclosed herein automatically alert a client and/or user of a pending due date. In one embodiment, a due date is a last free day, i.e., the day for when a Physical, Concrete and Tangible Object must leave a port yard. In one embodiment, the due date changes, e.g., the day for a payment for services, the time to submit a form, an arrival date, etc. In one embodiment, a due date is presented on a timeline. In one embodiment, all due dates for a freight shipping itinerary are presented on a timeline. In one embodiment, all dues for two or more freight shipping itineraries are presented on a timeline.

In one embodiment, the methods and systems disclosed herein comprise sorting the collection of dispatch matters according to the user's inputted criteria.

As used herein, the term “sorting the collection of dispatch matters according to the user inputted criteria” refers to arranging relevant information regarding the movement of a Physical, Concrete and Tangible Object based on a particular criteria, e.g., input form a client and/or user. In one embodiment, sorting a collection of dispatch matters according to a user's inputted criteria creates the ability for a user and/or client to view the movement of multiple Physical, Concrete and Tangible Objects at once, instead of viewing one delivery at a time. In one embodiment, viewing a particular type of dispatch matter for multiple freight shipping itineraries allows a user to batch the execution of dispatch matters thereby increasing overall efficiency, e.g., handling all customs forms at the same time, processing payment for freight services at the same time, confirming arrival dates at the same time. By not having to manually search through each freight shipping itinerary, a user saves time and can address dispatch matters in a thoughtful and deliberate manner.

In one embodiment, visualizing the end to end freight service is accomplished by presenting parallel and/or serial timelines on a Physical, Tangible Display Means.

As used herein, the term “parallel timeline” refers to a concrete representation of a chronological order of events for multiple shipments, organized side by side. In one embodiment, the parallel timeline is presented on a Physical, Tangible Display Means, e.g., a screen, a computer, a mobile device, etc. In one embodiment, the parallel timeline comprises a collection of dispatch matters. In one embodiment, visualizing the parallel timeline allows a user to manage the movement of multiple Physical, Concrete and Tangible Objects at the same time. In one example, a user can track the progress of different movements of Physical, Concrete and Tangible Objects on the same Physical, Tangible Display Means, e.g., the same screen. In one embodiment, the parallel timeline comprises the movement of Physical, Concrete and Tangible Objects for the same client. In one embodiment, the parallel timeline comprises a particular dispatch matter for Physical, Concrete and Tangible Objects for two or more clients.

As used herein, the term “serial timeline” refers to a concrete representation of a logical progression of addressing, replying, and/or executing dispatch matters for the movement of a Physical, Concrete and Tangible Object. In one embodiment, the serial timeline is presented on a Physical, Tangible Display Means, e.g., a screen, computer, a mobile device, etc. In one embodiment, a serial timeline comprises all of the dispatch matters for the movement of a Physical, Concrete and Tangible Object. In one embodiment, a user and/or client combine two or more serial timelines into a parallel timeline.

Presenting an aggregated list of dispatch matters on a graphical user interface in a series of parallel and/or serial timelines provides a user with the ability to better comprehend the dispatch matters and the necessary order of actions. In one embodiment, the methods and systems disclosed herein allows for batching similar tasks. In one example, a user can handle all customs related dispatch matters for multiple clients.

The timelines generated by the methods and systems disclosed herein provide a comprehensive overview of the movement of mass within a concrete representation. Visualizing the movement of mass in a concrete presentation provides an easier, efficient, and rapid method of managing freight services as opposed to keeping track of separate books and having to organize the freight service separately for each shipment and/or for each client.

In one embodiment, the concrete representation of parallel and/or serial timelines comprises a map. In one embodiment, the map comprises markers designating ports. In one embodiment, the map comprises markers designating railroad tracks. In one embodiment, the map comprises markers designating roads. In one embodiment, the map comprises markers designating shipping lanes. In one embodiment, the map comprises markers designating ports. In one embodiment, the map comprises markers representing the physical location of Physical, Concrete and Tangible Object.

In one embodiment, the parallel and/or serial timelines comprise an exception event. In one embodiment, the exception event is a delay at a port. In one embodiment, the exception event is a customs check. In one embodiment, the exception event is a non-receipt of payment.

In one embodiment, the parallel and/or serial timelines comprise a flowchart. In one embodiment, the flowchart presents a collection dispatch matters in a diagram illustrating all or some of the steps required for completing a delivery and how those steps interact.

In one embodiment, the methods and systems disclosed herein comprise an exception event.

As used herein, the term “exception event” refers to an occurrence changing and/or delaying the movement of mass. In one embodiment, an exception event is an unforeseen circumstance changing the priority of dispatch matters. In one embodiment, the methods and systems disclosed herein automatically record an exception event. In one embodiment, the methods and systems disclosed herein automatically alert a user and/or client of an exception event. In one embodiment, the methods and systems disclosed herein automatically prompt a user and/or client for an action or instruction addressing an exception. In one embodiment, the methods and systems disclosed herein automatically provide a recommendation for responding to an exception event. In one embodiment, the methods and systems disclosed herein automatically execute an action designed for addressing an exception event. In one embodiment, the methods and systems disclosed herein monitor the movement of a Physical, Concrete and Tangible Object in real time and contemporaneously identifies exception events. In some contexts, an exception event is a known possible occurrence, e.g., a delay at a port for unloading mass, a freight service not fulfilling a delivery request, a longer travel time than estimated, etc. In one embodiment, the methods and systems disclosed herein determine the likelihood of an exception event. In one embodiment, an exception event is an unknown circumstance. In one embodiment, an exception event is an act of God delaying the movement of mass, e.g., a hurricane delaying a ship, an earthquake damaging roads, a storm causing delays for an airplane, etc. In one embodiment, an exception event is a logistical and/or clerical error, e.g., the loss or misfiling of a form, a late payment, a missed deadline, etc. In one embodiment, an exception event is a lack of a Physical, Concrete and Tangible Object, e.g., a product no longer in stock, a damaged Physical, Concrete and Tangible Object, the disappearance of mass in transit, etc. In one embodiment, an the exception event is a delay in time, e.g., a lack of space on a ship delaying delivery, a weather event delaying takeoff of an airplane, a due date changing, etc. In one embodiment, there are multiple exception events.

Within the context of this disclosure, an exception event comprises any event that is not within the control of the user or client. In one example, an exception event is a storm that causes the delay of an airplane. In one example, an exception event is the destruction of the Physical, Concrete and Tangible Object. In one embodiment, an exception event requires generating a new dispatch matter, e.g., an insurance form, new freight service, new payment of service, etc. In one embodiment, an exception event is a delay at a port, e.g., a congestion of ships delaying movement, an issue with customs clearance, a ship having to reroute, etc.

In one embodiment, the delay at a port is a weather delay, e.g., a storm causing a change in arrival time, a mudslide causing a reroute of mass, an earthquake destroying a Physical, Concrete and Tangible Object, etc.

In one embodiment, methods and systems disclosed herein comprise resorting the collection of dispatch matters in response to an exception event.

As used herein, the term “resorting the collection of dispatch matters in response to an exception event” refers to organizing a previously sorted collection of dispatch matters when an exception event occurs. In one embodiment, an exception event occurs without prior knowledge of the user or client. In one embodiment, the exception event is a new dispatch matter created during the movement of mass not previously anticipated, e.g., the destruction of Physical, Concrete and Tangible Object, a delay of service, an increase of fuel costs, etc. In one embodiment, the methods and systems disclosed herein automatically alert a client and/or user of an exception event. In one embodiment, the methods and systems disclosed herein recommend an action for responding to an exception event, e.g., selecting a new freight service, choosing a new arrival date, cancelling a delivery, etc. In one embodiment, the occurrence of an exception event does not rearrange the collection of dispatch matters.

In one embodiment, a sequential dispatch matter is queued.

As used herein, the term “sequential dispatch matter” refers to a dispatch matter presented in a specific order based on a user and/or client action. In one embodiment, a sequential order of dispatch matters comprises each individual step for moving mass. In one embodiment, a sequential order of dispatch matters is presented in a chronological order, e.g., by due date. In one embodiment, a sequential order of dispatch matters is presented in a logical progression, e.g., selecting a freight service before submitting a customs form, confirming the arrival of mass at a destination before rendering payment, etc. In one embodiment, a sequential dispatch matter is determined by an action, e.g., paying a fee, confirming a freight service, approving a change in delivery, etc. In one embodiment, the methods and systems disclosed herein automatically present dispatch matters in a sequential order. In one embodiment, the methods and systems disclosed herein present dispatch matters in a sequential matter based on a user and/or client preference or input, e.g., chronologically by due date, progression of actions, etc.

As used herein, the term “queued” refers to presenting a dispatch matter based on the action of a user and/or client. In one embodiment, a dispatch matter is queued based on the execution of a dispatch matter. In one embodiment, a dispatch matter is queued based a client and/or user selecting a new dispatch matter. In one embodiment, queuing dispatch matters is a practical matter for comprehending the necessary steps for accomplishing the movement of mass. In one embodiment, a dispatch matter is automatically queued, e.g., presenting a dispatch matter in the next sequential order of operations, alerting a user of a dispatch matter delaying the movement of mass, presenting an exception event delaying the movement of mass, etc.

In one embodiment, the methods and systems disclosed herein comprise complex filtering.

As used herein, the term “complex filtering” refers to dividing and/or processing a shipment or multiple shipments into individual categories. In one embodiment, complex filtering comprises presenting dispatch matters for a shipment to a user and/or a client.

In one embodiment, complex filtering allows a user and/or client to view certain groups of dispatch matters for easier task management. In one embodiment, complex filtering provides a user the with ability to quickly comprehend the various tasks for each delivery without having to search through the entire collection of dispatch matters.

Viewing dispatch matters in the context of the entire collection and viewing dispatch matters in isolated groups provides a user unprecedented control on how best to handle moving one or more Physical, Concrete and Tangible Objects. In some contexts, viewing the entire collection of dispatch matters is required for assessing the current standing of all the client's deliveries. In some contexts, viewing the filtered dispatch matters allows for easier day to day task management. The ability to switch back and forth between the entire collection and filtered dispatch matters fulfills an unmet need over previous methods and systems for managing end to end freight services.

Disclosed herein, is an end to end freight service management system, comprising:
a docket of freight shipping itineraries;
an organization of dispatch matters; and
a graphical user interface.

As used herein, the term “docket of freight shipping itineraries” refers to a collection of freight shipping itineraries. In one embodiment, a docket of freight shipping itineraries comprises logistical information relating to the movement of mass, e.g., arrival date, cost of services, the route of movement, etc. In one embodiment, a user extracts information from a docket of freight shipping itineraries to create an organization of dispatch matters. In one embodiment, the methods and systems disclosed herein automatically create dispatch matters from a docket of freight shipping itineraries, e.g., sharing information with a Cloud database, transferring information utilizing an application interface program, etc. In one embodiment, a user creates an arrangement of dispatch matters from a docket of freight shipping itineraries. In one embodiment, a docket of freight shipping itineraries comprises the information for the movement of a Physical, Concrete and Tangible Object owned by a client. In one embodiment, a docket of freight shipping itineraries comprises the information for the movement of multiple Physical, Concrete and Tangible Objects owned by a single client. In one embodiment, a docket of freight shipping itineraries comprises information pertaining to moving multiple Physical, Concrete and Tangible Objects owned by one or more entities.

As used herein, the term “organization of dispatch matters” refers to a concrete representation of a compilation of input relevant for moving a Physical, Concrete and Tangible Object in a particular arrangement. In one embodiment, an organization of dispatch matters is automatically created, e.g., extracting information from a freight shipping itinerary, utilizing historical data to generate dispatch matters, relying on a user's preference and/or input, etc. In one embodiment, an organization of dispatch matters is arranged based on a user's preference, e.g., inputting, filtering, and/or selecting information, utilizing a graphical user interface to manipulate a concrete representation, etc. In one embodiment, the methods and systems disclosed herein prompt a user for input, e.g., a preference as to sorting by a particular type of dispatch matter, sorting by due date, sorting by client, etc.

In one embodiment, an organization of dispatch matters comprises a collection of parallel and/or serial timelines. In one embodiment, an organization of dispatch matters comprises a collection of parallel timelines. In one embodiment, an organization of dispatch matters comprises a collection of serial timelines.

Although the present invention herein has been described with reference to various exemplary embodiments, it is to be understood that these embodiments are merely illustrative of the principles and applications of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

What is claimed is:

1. A method of managing an end to end freight service, comprising:
accessing a freight shipping itinerary;
extracting a collection of dispatch matters from the freight shipping itinerary; and
presenting the collection of dispatch matters on a Physical, Tangible Display Means according to a user's inputted criteria.

2. The method of claim 1, comprising complex filtering.

3. The method of claim 1, comprising sorting the collection of dispatch matters according to the user's inputted criteria.

4. The method of claim 3, wherein the inputted criteria comprises a due date.

5. The method of claim 3, wherein the inputted criteria comprises a geographic location.

6. The method of claim 1, comprising an exception event.

7. The method of claim 6, comprising resorting the collection of dispatch matters in response to an exception event.

8. The method of claim 1, comprising multiple freight shipping itineraries.

9. An end to end freight service management system, comprising:
a docket of freight shipping itineraries;
an organization of dispatch matters; and
a graphical user interface.

10. The system of claim 9, comprising an exception event.

11. The system of claim 9, comprising a geographic location.
